(19) United States
(12) Patent Application Publication
(10) Pub. No.: US 2025/0118929 A1
(43) Pub. Date: Apr. 10, 2025

(54) ELECTRICAL CONNECTOR ASSEMBLY

(71) Applicant: Lear Corporation, Southfield, MI (US)

(72) Inventors: Leyuan Sang, Jiangsu Yangzhou (CN); Chao Fang, Shanghai (CN)

(73) Assignee: Lear Corporation, Southfield, MI (US)

(21) Appl. No.: 18/899,186

(22) Filed: Sep. 27, 2024

(30) Foreign Application Priority Data
Oct. 10, 2023 (CN) 202311310302.4

(51) Int. Cl. H01R 13/629; H01R 13/6581

(52) U.S. Cl. CPC H01R 13/62927; H01R 13/6581

(57) ABSTRACT

An electrical connector assembly having an assist lever pivotable to pull a first electrical connector into contact with a second electrical connector and a CPA member slidably mounted in the assist lever for selectively locking the assist lever in place relative to the first electrical connector. An electrical connector assembly having a spring terminal mountable within a main housing and retained by elastically flexible mounting latches. An electrical connector assembly having an outer electromagnetic shielding member mountable within the main housing and retained by elastically flexible retaining tabs.

### BACKGROUND

This disclosure relates to an electrical connector assembly, and more particularly to an electrical connector assembly with a connector position assurance element.

Electrical connector assemblies are known that provide convenient and quick electrical connections. Some electrical connector assemblies may employ a cantilever lever to assist in bringing the electrical connector pair into engagement. Some may also provide connector position assurance (CPA) to assure that a connection remains securely in place. It is desirable to provide an electrical connector assembly with a cantilever lever and CPA element that is relatively quick and easy to assemble, relatively quick and easy to mate connectors together, and which retains the connectors in the desired positions.

### SUMMARY

According to an aspect, an embodiment provides an electrical connector assembly including: a first electrical connector including a main housing having a pair of opposed lever pivot pins extending in a lateral direction, an opening configured to receive a second electrical connector, and a lock flange extending in a longitudinal direction and including a lock passage; an assist lever including a pair of spaced apart lever arms extending in the longitudinal direction and connected by a lever crossmember, wherein each lever arm includes a pivot pin hole configured to mate with a respective one of the lever pivot pins to pivotally mount the assist lever to the main housing, a pair of cam slots configured to mate with respective camming pins of the second electrical connector and selectively cam the second electrical connector toward and away from the main housing when the assist lever is pivoted relative to the main housing, and a CPA cavity in the lever crossmember; and a CPA member slidably received in the CPA cavity for sliding in the longitudinal direction and including a pair of slider arms retaining the CPA member in the lever crossmember for pivoting with the assist lever, and a lock arm configured to slide longitudinally into the lock passage when the assist lever is in a connector secure position to selectively prevent the assist lever from pivoting relative to the main housing.

According to an aspect, an embodiment provides an electrical connector assembly that includes an assist lever for assistance in connecting a pair of electrical connectors together. According to an aspect, an embodiment provides a connector position assurance (CPA) member that assures that the connectors remain in a fully connected position. The CPA member may include lock arms that selectively secure the CPA member and assist lever in a connector secure position relative to the main housing of the electrical connector assembly. The CPA member may include disengaging force arms that selectively secure the CPA member relative to the assist lever. The CPA member may include slider arms and retention barbs that slidably retain the CPA member to the assist lever. The assist lever may include a cam slot, which is engageable with camming pins on a second electrical connector to pull the second electrical connector into full contact (a connection secure position) as the assist lever is pivoted about lever pivot pins extending from a first electrical connector.

According to an aspect, an embodiment provides a spring terminal, which may be formed from a single piece of metal, that mounts in the electrical connector assembly without needing welding, adhesive or fasteners to retain the spring terminal in position. The spring terminal may be secured in position with mounting latches engaging with retention slots in a connector body. The spring terminal may be secured in position by contact spring securement flanges extending from the main housing of the electrical connector assembly.

According to an aspect, an embodiment provides an outer electromagnetic (EM) shielding that mounts to the main housing with retention tabs and a seating flange engaging an outer wall of an opening in the main housing of the first electrical connector. The outer EM shielding does not need fasteners, adhesive or welding to be retained in the mounted position. The outer EM shielding may include ribs that contact an inner electromagnetic (EM) shielding to provide continuous electromagnetic shielding between the outer and inner EM shielding.

Various aspects of this invention will become apparent to those skilled in the art from the following detailed description of the embodiments, when read in light of the accompanying drawings.

### BRIEF DESCRIPTION OF THE DRAWINGS

FIG. 1 is a schematic, perspective view of a portion of an electrical connector assembly.

FIG. 2 is a schematic, perspective view of a portion of the electrical connector assembly of FIG. 1, but from a different perspective.

FIG. 3 is a schematic, perspective view of a portion of the electrical connector assembly of FIG. 1, but from a different perspective.

FIG. 4 is a schematic, perspective view of a main housing of the electrical connector assembly.

FIG. 5 is a schematic, perspective view of a connector position assurance (CPA) member.

FIG. 6 is a schematic, partially sectional view of a CPA member positioned in a locked position relative to a main housing.

FIG. 7 is a schematic, perspective view of an assist lever.

FIG. 8 is a schematic, partially sectional, elevation view of a CPA member mounted to an assist lever.

FIG. 9 is a schematic, partially sectional, perspective view of a CPA member mounted to an assist lever.

FIG. 10 is a schematic, perspective view of a connector body with spring terminals mounted thereon.

FIG. 11 is a schematic, partially sectional, perspective view of a connector body with spring terminals mounted thereon.

FIG. 12 is a schematic, partially sectional, perspective view of a connector body mounted to a main body.

FIG. 13 is a schematic, perspective view of a spring terminal.

FIG. 14 is a schematic, perspective view of the main housing, similar to FIG. 4, but from a different perspective.

FIG. 15 is a schematic, perspective view of an outer EM Shielding.

FIG. 16 is a schematic, partially sectional, perspective view of an outer EM shielding mounted to a main housing.

FIG. 17 is a schematic, partially sectional, perspective view of an outer EM shielding and an inner EM shielding mounted to a main housing.

FIG. 18 is a schematic, partially sectional, perspective view of an outer EM shielding and an inner EM shielding mounted to a main housing.

### DETAILED DESCRIPTION OF THE EMBODIMENTS

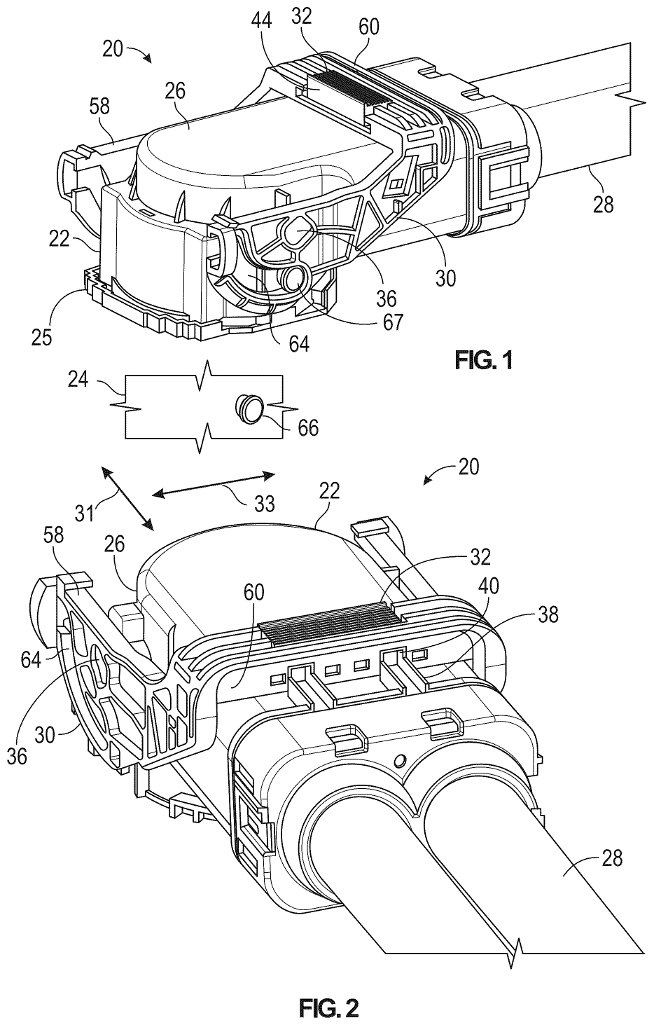

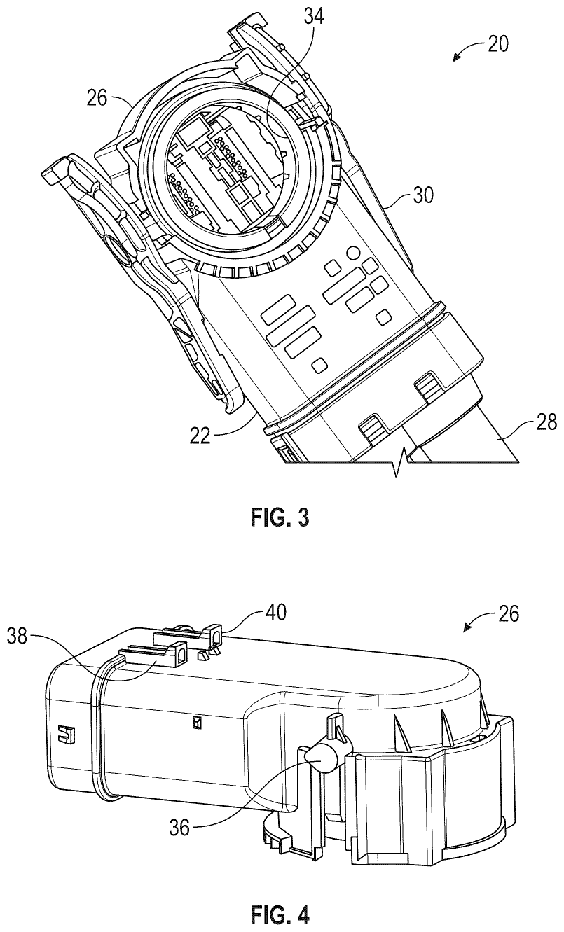

Referring now to FIGS. 1-3, an example of an electrical connector assembly 20 is illustrated. The electrical connector assembly 20 includes a first electrical connector 22 and a second electrical connector 24 (a portion of which is illustrated schematically in FIG. 1). The first electrical connector 22 includes a main housing 26, which receives electrical cables 28. An assist lever 30 is pivotally mounted to the main housing 26, and a connector position assurance (CPA) member 32 is slidably mounted to the assist lever 30. A protective cap 25 may be mounted to the first electrical connector 22 prior to insertion of the second electrical connector 24 into the first electrical connector 22. The protective cap 25 may be employed, for example, to hold a face seal (not shown) in position on the first electrical connector 22 prior to assembly to the second electrical connector 24.

When referring to the orientation of components of the electrical connector assembly 20 herein, a longitudinal direction 31 is oriented in the direction of arrows 31 shown in FIG. 2, and a lateral direction 33 is oriented in the direction of arrows 33 shown in FIG. 2.

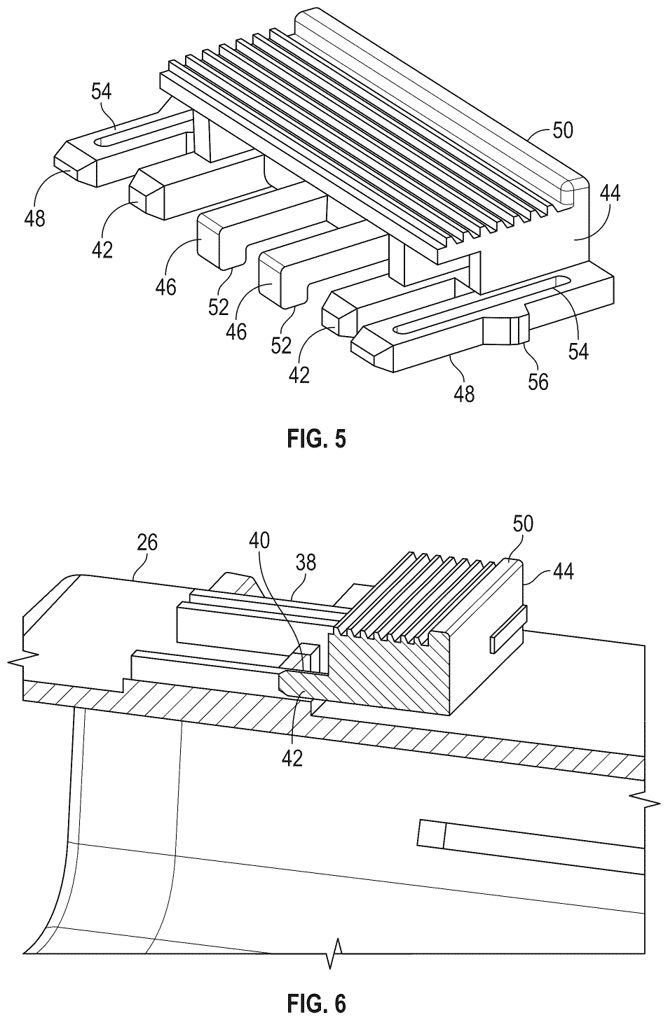

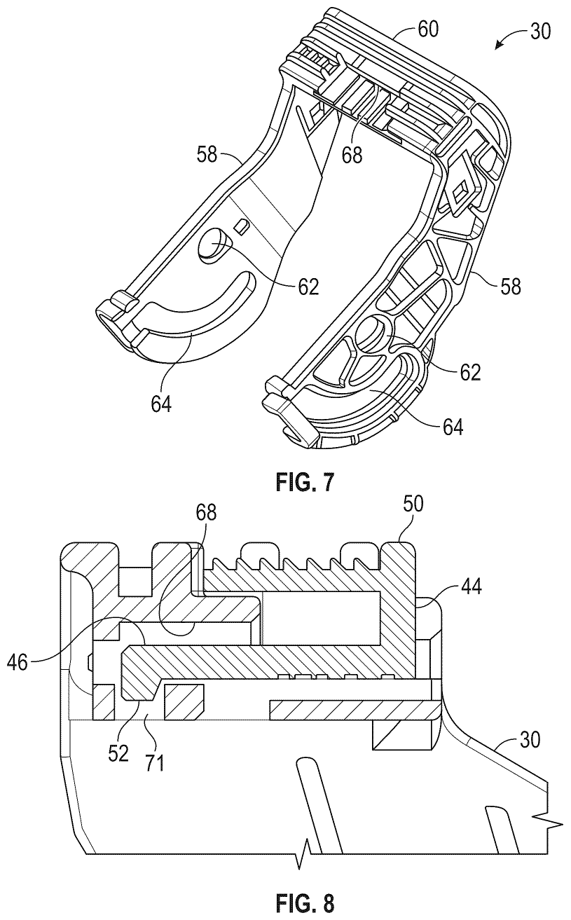

Referring now to an example illustrated in FIGS. 4-9, in view of FIGS. 1-3, the main housing 26 includes an opening 34 for receiving the second electrical connector 24, a pair of lever pivot pins 36, extending in a lateral direction 33, about which the assist lever 30 pivots, and a pair of lock flanges 38, each including a lock passage 40 configured to receive a respective one of a pair of lock arms 42 extending in a longitudinal direction 31 from a main body 44 of the CPA member 32.

The CPA member 32, in addition to the pair of lock arms 42, includes a pair of disengaging-force arms 46, which extend from the main body 44 generally parallel to the lock arms 42, a pair of slider arms 48, which extend from the main body 44 generally parallel to the lock arms 42, and a finger pull flange 50, which extends in a lateral direction 33 across the main body 44. The disengaging-force arms 46 are elastically flexible and each includes retention tabs 52 extending away from the disengaging-force arms 46. Each of the slider arms 48 includes a longitudinally extending slot 54 and a retention barb 56 extending laterally outward from the slider arm 48.

The assist lever 30 includes a pair of lever arms 58, which extend in a generally longitudinal direction 31, connected by a lever crossmember 60, which extends between the lever arms 58. Each of the lever arms 58 includes a pivot pin hole 62 that mates with a respective one of the lever pivot pins 36 for pivoting about an axis extending in the generally lateral direction 33. Each of the lever arms 58 also includes a cam slot 64 configured to mate with, contain, and release camming pins 66 of the second electrical connector 24. The cam slots 64 may also mate with, contain and release pins 67 of the protective cap 25 to hold the protective cap 25 in place prior to assembly of the first and second electrical connectors 22, 24. The lever crossmember 60 includes a CPA cavity 68 configured to slidably receive the CPA member 32. Within the CPA cavity 68 are retention barb cavities 70 configured to mate with the retention barbs 56.

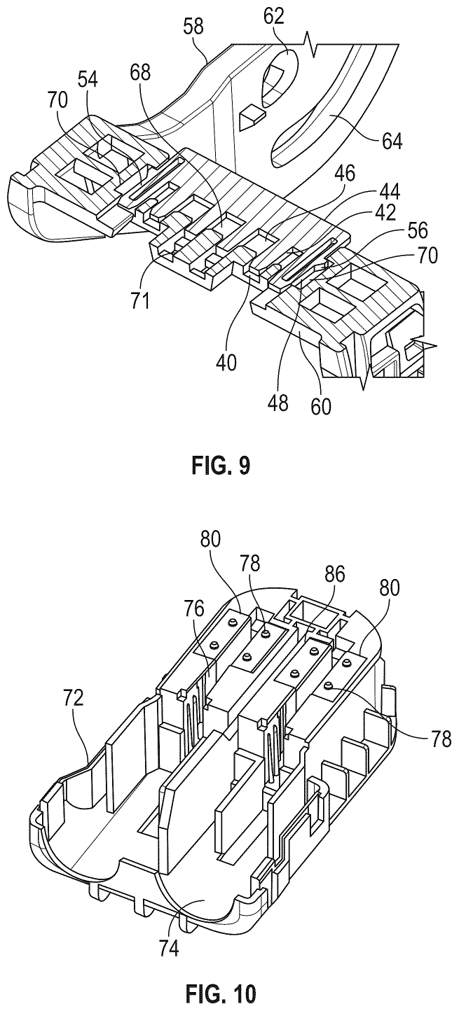

The assembly and operation of the assist lever 30 and the CPA member 32 will now be discussed. The CPA member 32 is slid into the CPA cavity 68 of the assist lever 30 (in a generally longitudinal direction 31), with the longitudinal extension slots 54 allowing the slider arms 48 to elastically flex when the retention barbs 56 begin to slide into the CPA cavity 68. As the CPA member 32 is slid further (in the longitudinal direction 31) into the CPA cavity 68, the retention barbs 56 reach their respective retention barb cavities 70, with the extension slots 54 expanding to push the retention barbs 56 (in the lateral direction 33) into the retention barb cavities 70. The CPA member 32 is now retained in the assist lever 30. As the CPA member 32 was being slid into the CPA cavity 68, the retention tabs 52 of the disengaging-force arms 46 cause the disengaging-force arms 46 to elastically flex, which holds the CPA member 32 in a release position (illustrated in FIG. 9). The release position is a position of the CPA member 32 relative to the assist lever 30 where the CPA member 32 does not engage the main housing 26 when the assist lever 30 is pivoted into a full contact (connector secure) position (as illustrated in FIG. 2).

The assist lever 30 is mounted to the main housing 26 by flexing the lever arms 58 outward in a lateral direction and moving the lever arms 58 around the lateral sides of the main housing 26 until each of the pivot pin holes 62 of the lever arms 58 align with a corresponding lever pivot pin 36 of the main housing 26. The assist lever 30 is now pivotable relative to the main housing 26 about a laterally extending axis.

Connecting the first electrical connector 22 to the second electrical connector 24 includes pivoting the assist lever 30, about the lever pivot pins 36, into a connector engagement position. The connector engagement position is where the assist lever 30 is pivoted counterclockwise (from the position illustrated in FIGS. 1-3) so that the lever crossmember 60 is pivoted away from the main housing 26 and openings at the ends of the cam slots 64 extend outward from the main housing 26 adjacent to and on opposite sides of the opening 34. The second electrical connector 24 is then aligned, on the side of the main housing 26 with the opening 34, with the first electrical connector 22 so that the camming pins 66 will slide through the openings into the respective cam slots 64. The first and second electrical connectors 22, 24 are pushed toward one another until the camming pins 66 are in the respective cam slots 64. The assist lever 30 is then pivoted from the connector engagement position to the full contact (connector secure) position, where the engagement of the camming pins 66 with the cam slots 64, as the assist lever 30 is pivoted, causing the first and second electrical connectors 22, 24 to be pulled into full engagement with each other.

At this point, with the assist lever 30 being in the full contact (connector secure) position, the CPA member 32 is now adjacent to the lock passages 40 of the lock flanges 38 on the main housing 26. The CPA member 32 is then slid longitudinally from its release position to a lock position where the lock arms 42 are engaged in the lock passages 40 of the lock flanges 38. The lock position is illustrated in FIGS. 1, 6 and 8. As the CPA member 32 is slid into the lock position, the retention tabs 52 align with the retention tab cavities 71 in the lever crossmember 60, and flex down into the retention tab cavities 71 (illustrated in FIG. 8), thus holding the CPA member 32 in the lock position. The CPA member 32 in the lock position prevents the lever crossmember 60 of the assist lever 30 from moving away from the main housing 26, thus preventing the assist lever 30 from pivoting. This holds the first and second electrical connectors 22, 24 in full engagement.

To disengage the first and second electrical connectors 22, 24, one may employ the finger pull flange 50 to pull the CPA member 32 with sufficient force to cause the disengaging-force arms 46 to flex and allow the retention tabs 52 to lift out of the retention tab cavities 71. The CPA member 32 is then slid longitudinally until the retention barbs 56 engage an end of the retention barb cavities 70 (illustrated in FIG. 9), the CPA member release position. The CPA member 32 remains mounted on the assist lever 30. As the CPA member 32 was slid into the release position, the lock arms 42 slide out of the lock passages 40. The assist lever 30 can now be pivoted (counterclockwise relative to the position illustrated in FIG. 1), with the cam slots 64 acting on the camming pins 66 to push the first and second electric connectors 22, 24 apart.

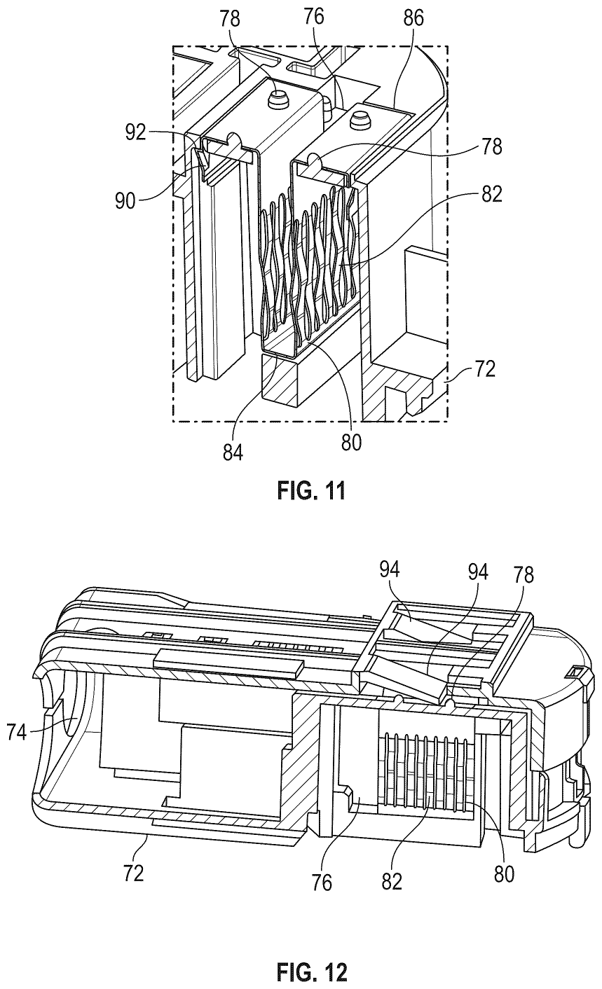

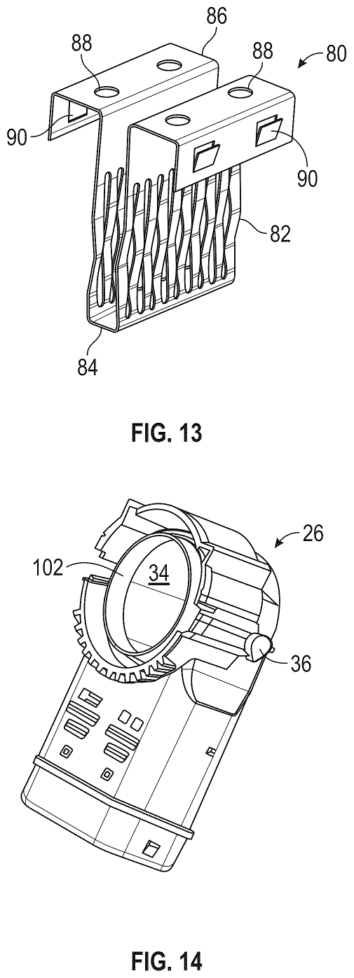

Referring now to an example illustrated in FIGS. 10-13, in view of FIGS. 1-3, a connector body 72 is contained within the main housing 26. The connector body 72 includes a pair of cable passages 74, which receive ends of the electrical cables 28, contact spring cavities 76, each of which aligns with a respective one of the cable passages 74 and is configured to receive a respective spring terminal 80, and alignment posts 78 adjacent to the contact spring cavities 76. Each spring terminal 80 includes a pair of contact spring portions 82 connected by a base flange 84, a pair of mounting flanges 86, which each include alignment holes 88 that mate with the corresponding alignment posts 78 in order to align the spring terminal 80 in the respective contact spring cavity 76, and mounting latches 90, which are angled to engage retention slots 92 in the connector body 72 to retain the spring terminal 80 in the respective contact spring cavity 76. Contact spring securement flanges 94 may extend from a portion of the main housing 26 to assist in securing the spring terminals 80 in their respective contact spring cavities 76. The spring terminals 80 may each be formed from a single piece of sheet metal and may be assembled to the connector body 72 with an elastic snap fit-thus, no fasteners, adhesive or welding is needed to retain the spring terminals 80 in the contact spring cavities 76. The contact spring portions 82 allow for resilient connection of electrical contacts.

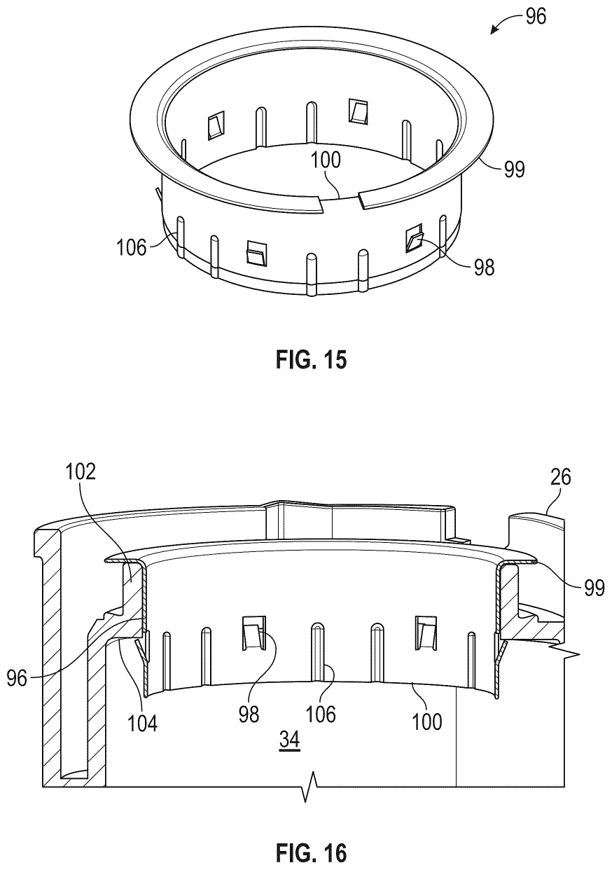

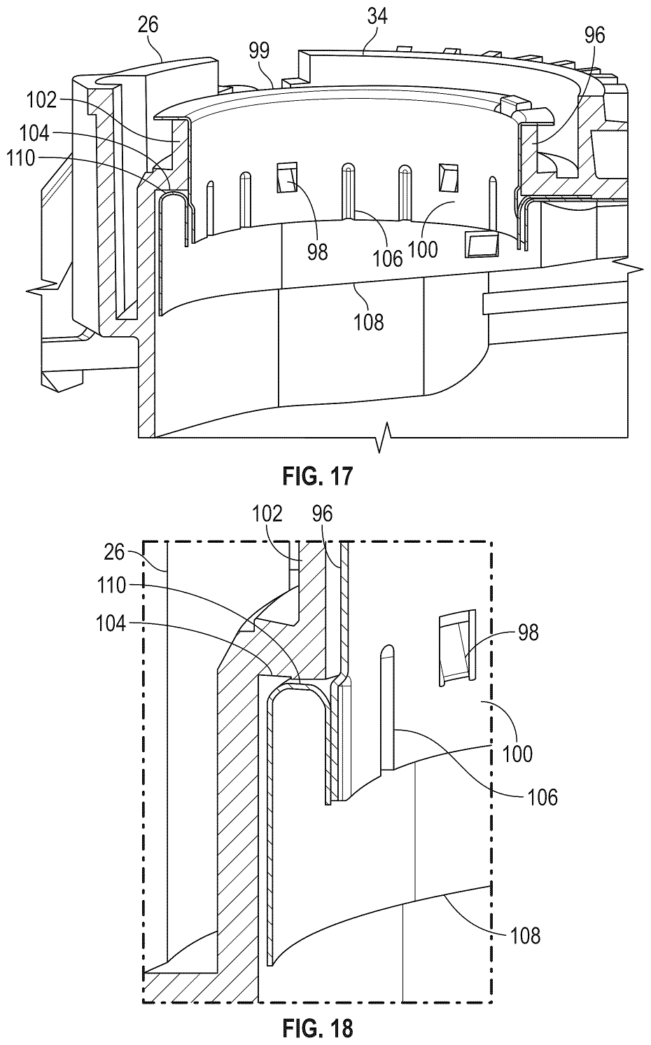

Referring now to an example illustrated in FIGS. 14-18, in view of FIGS. 1-3, an outer electromagnetic (EM) shielding 96 is mounted within the opening 34 of the main housing 26. The outer EM shielding 96 is made from a material that allows for electromagnetic shielding of the connectors in the electrical connector assembly 20. The outer EM shielding 96 includes retention tabs 98 and a seating flange 99. The retention tabs 98 angle radially outward from a wall 100 of the outer EM shielding 96 and are spaced from the seating flange 99 so that, as the outer EM shielding 96 is slid into the opening 34, the retention tabs 98 contact an outer wall 102 of the opening 34 and are elastically flexed radially inward until reaching a lip 104 at essentially the same location as the seating flange 99 abuts an end of the outer wall 102, at which time the retention tabs 98 spring outward. This secures the outer EM shielding 96 to the main housing 26. The outer EM shielding 96 also includes axially extending ribs 106 that protrude radially outward. The ribs 106 are configured to contact an inner electromagnetic (EM) shielding 108. The inner EM shielding 108 is radially larger than the outer EM shielding 96 and includes ribs 110 that contact the ribs 106 on the outer EM shielding 96 as well as abut the lip 104 to locate the inner EM shielding 108 relative to the outer wall 102 of the opening 34. The inner EM shielding 108 is made from a material that allows for electromagnetic shielding of the connectors in the electrical connector assembly 20.

The principle and mode of operation of this invention have been explained and illustrated. However, it must be understood that this invention may be practiced otherwise than as specifically explained and illustrated without departing from its spirit or scope.

What is claimed is:

1. An electrical connector assembly comprising:
a first electrical connector including a main housing having a pair of opposed lever pivot pins extending in a lateral direction, an opening configured to receive a second electrical connector, and a lock flange extending in a longitudinal direction and including a lock passage;
an assist lever including a pair of spaced apart lever arms extending in the longitudinal direction and connected by a lever crossmember, wherein each lever arm includes a pivot pin hole configured to mate with a respective one of the lever pivot pins to pivotally mount the assist lever to the main housing, a pair of cam slots configured to mate with respective camming pins of the second electrical connector and selectively cam the second electrical connector toward and away from the main housing when the assist lever is pivoted relative to the main housing, and a CPA cavity in the lever crossmember; and
a CPA member slidably received in the CPA cavity for sliding in the longitudinal direction and including a pair of slider arms retaining the CPA member in the lever crossmember for pivoting with the assist lever, and a lock arm configured to slide longitudinally into the lock passage when the assist lever is in a connector secure position to selectively prevent the assist lever from pivoting relative to the main housing.

2. The electrical connector assembly of claim 1 wherein the lever crossmember includes a retention tab cavity adjacent to the CPA cavity, and the CPA member includes a disengaging-force arm having a retention tab extending therefrom, wherein when the CPA member is slid longitudinally into a lock position the retention tab engages the retention tab cavity to bias the CPA member from being moved out of the lock position.

3. The electrical connector assembly of claim 2 wherein the lever crossmember includes a second retention tab cavity adjacent to the CPA cavity, and the CPA member includes a second disengaging-force arm having a second retention tab extending therefrom, wherein when the CPA member is slid longitudinally into the lock position the second retention tab engages the second retention tab cavity to bias the CPA member from being moved out of the lock position.

4. The electrical connector assembly of claim 2 wherein the retention tab is configured to abut the lever crossmember to cause the disengaging-force arm to elastically flex when the CPA member is not in the lock position, thereby biasing the CPA member to remain out of the lock position.

5. The electrical connector assembly of claim 4 wherein the first electrical connector includes a contact spring cavity having a pair of contact spring securement flanges, and wherein the electrical connector assembly includes a spring terminal mounted in the contact spring cavity, with the spring terminal including a pair of contact spring portions connected by a base flange, a pair of mounting flanges, each extending from a respective one of the contact spring portions, and mounting latches extending outward from the mounting flanges to elastically engage respective ones of the contact spring securement flanges to retain the spring terminal in the contact spring cavity.

6. The electrical connector assembly of claim 4 wherein the main housing includes an outer wall that defines the opening, with the outer wall including a lip, and wherein the electrical connector assembly further includes an outer electromagnetic shielding having a generally cylindrical wall that includes retention tabs that are angled radially outward, the retention tabs configured to elastically flex radially inward against the outer wall and elastically flex outward against the lip to retain the outer electromagnetic shielding in the opening.

7. The electrical connector assembly of claim 1 wherein the CPA cavity includes a pair of retention barb cavities, and each of the slider arms includes a retention barb extending therefrom that is configured to be received in a respective one of the retention barb cavities to retain the CPA member in the lever crossmember while allowing for longitudinal sliding of the CPA member relative to the lever crossmember.

8. The electrical connector assembly of claim 7 wherein each of the slider arms includes a longitudinally extending longitudinal extension slot configured to allow each of the slider arms to elastically flex as the retention barbs are being moved into the respective retention barb cavities.

9. The electrical connector assembly of claim 1 wherein the first electrical connector includes a contact spring cavity having a pair of retention slots, and wherein the electrical connector assembly includes a spring terminal mounted in the contact spring cavity, with the spring terminal including a pair of contact spring portions connected by a base flange, a pair of mounting flanges, each extending from a respective one of the contact spring portions, and mounting latches extending outward from the mounting flanges to elastically engage respective ones of the retention slots to retain the spring terminal in the contact spring cavity.

10. The electrical connector assembly of claim 9 wherein each of the mounting flanges includes alignment holes, and the first electrical connector includes alignment posts extending therefrom configured to engage corresponding alignment holes to orient the spring terminal in the contact spring cavity.

11. The electrical connector assembly of claim 9 wherein the spring terminal is formed from a single piece of sheet metal.

12. The electrical connector assembly of claim 11 wherein the main housing includes an outer wall that defines the opening, with the outer wall including a lip, and wherein the electrical connector assembly further includes an outer electromagnetic shielding having a generally cylindrical wall that includes retention tabs that are angled radially outward, the retention tabs configured to elastically flex radially inward against the outer wall and elastically flex outward against the lip to retain the outer electromagnetic shielding in the opening.

13. The electrical connector assembly of claim 9 wherein the main housing includes a contact spring securement flange extending therefrom that is biased against at least one of the mounting flanges to bias the spring terminal into the contact spring cavity.

14. The electrical connector assembly of claim 9 wherein the main housing includes an outer wall that defines the opening, with the outer wall including a lip, and wherein the electrical connector assembly further includes an outer electromagnetic shielding having a generally cylindrical wall that includes retention tabs that are angled radially outward, the retention tabs configured to elastically flex radially inward against the outer wall and elastically flex outward against the lip to retain the outer electromagnetic shielding in the opening.

15. The electrical connector assembly of claim 1 wherein the main housing includes an outer wall that defines the opening, with the outer wall including a lip, and wherein the electrical connector assembly further includes an outer electromagnetic shielding having a generally cylindrical wall that includes retention tabs that are angled radially outward, the retention tabs configured to elastically flex radially inward against the outer wall and elastically flex outward against the lip to retain the outer electromagnetic shielding in the opening.

16. The electrical connector assembly of claim 15 wherein the outer electromagnetic shielding includes a seating flange that is configured to abut the outer wall when the retention tabs are engaged with the lip to fix the outer electromagnetic shielding in the opening.

17. The electrical connector assembly of claim 16 wherein the outer electromagnetic shielding is formed from a single piece of sheet metal.

18. The electrical connector assembly of claim 15 wherein the outer electromagnetic shielding is formed from a single piece of sheet metal.

19. The electrical connector assembly of claim 15 wherein the generally cylindrical wall includes radially outwardly extending ribs that are configured to contact an inner electromagnetic shielding when the outer electromagnetic shielding is mounted in the opening.

20. The electrical connector assembly of claim 19 wherein the lip is configured to abut inner shielding ribs of the inner electromagnetic shielding when the inner electromagnetic shielding is mounted in the main housing.
